(19) United States
(12) Patent Application Publication
(10) Pub. No.: US 2017/0190413 A1
(43) Pub. Date: Jul. 6, 2017

(54) AIRCRAFT WING WITH SPOILER

(71) Applicants: Airbus Defence and Space GmbH, Taufkirchen (DE); Airbus Operations GmbH, Hamburg (DE)

(72) Inventors: Heinz Hansen, Hamburg (DE); Johannes Kirn, Muenchen (DE); Wolfgang Machunze, Oberhaching (DE); Christian Metzner, Muenchen (DE); Markus J. Weber, Hamburg (DE)

(73) Assignees: Airbus Defence and Space GmbH, Taufkirchen (DE); Airbus Operations GmbH, Hamburg (DE)

(21) Appl. No.: 15/384,509

(22) Filed: Dec. 20, 2016

(30) Foreign Application Priority Data
Dec. 30, 2015 (EP) 15 203 196.9

(51) Int. Cl. B64C 9/14; B64C 13/28

(52) U.S. Cl. CPC B64C 9/14; B64C 13/28

(57) ABSTRACT

An aircraft wing has a spoiler movable from a reference position with a deflection angle α_{ref} to a given target deflection angle α_{target} by an actuator powered mechanism. An upstream edge of the spoiler is interconnected with the aircraft wing exclusively via a strip element made of a resiliently flexible material and via the actuator powered mechanism. A downstream edge of the strip element extends along the whole or at least along a major part of the upstream edge of the spoiler. The actuator powered mechanism is constructed and arranged such that, while moving the spoiler, the strip element is bent with a constant strain along the strip element. A cross-section of the strip element for all deflection angles α assumes the form of a ring segment with a radius R(α) at least within a given margin of failure, with α, α_{target}, α_{ref}ε[−α₁; α₂].

### FIELD OF THE INVENTION

The invention relates to an aircraft wing with a spoiler, especially with a high lift spoiler. The spoiler is being movable from a reference position with a deflection angle α_{ref} to a given target deflection angle α_{target} by an actuator powered mechanism.

### BACKGROUND OF THE INVENTION

A spoiler, sometimes called a “lift spoiler” or “lift dumper”, is a device intended to reduce lift in an aircraft. Spoilers are plates on the top surface of a wing that can be extended upward into the airflow to spoil it. By so doing, the spoiler creates a controlled stall over the portion of the wing behind it, greatly reducing the lift of that wing section. Spoilers differ from airbrakes in that airbrakes are designed to increase drag without affecting lift, while spoilers reduce lift as well as increasing drag. Spoilers fall into two categories: those that are deployed at controlled angles during flight to increase descent rate or control roll, and those that are fully deployed immediately on landing to greatly reduce lift (“lift dumpers”) and increase drag. In modern fly-by-wire aircraft, the same set of control surfaces serve both functions. Spoilers can be used to slow an aircraft, or to make an aircraft descend, if they are deployed on both wings. Spoilers can also be used to generate a rolling motion for an aircraft, if they are deployed on only one wing.

The reduction of aerodynamic drag of aircraft wings is one of several research topics relevant for a better performance of the respective aircraft and a reduction of fuel burn. It is known that an optimal future laminar aircraft wing achieves for most or all operational aerodynamic situations a laminar boundary layer across the aircraft wing without any or only minimal turbulent air flow.

### BRIEF SUMMARY OF THE INVENTION

There may be a need to provide an aircraft wing with a spoiler, especially a high lift spoiler, with reduced aerodynamic drag.

A first aspect provides an aircraft wing with a spoiler, the spoiler is being movable from a reference position with a deflection angle α_{ref} to a given target deflection angle α_{target} by an actuator powered mechanism. The proposed aircraft wing is characterized in that the spoiler is interconnected with the aircraft wing exclusively via a strip element and via the actuator powered mechanism, wherein an upstream edge of the spoiler is being interconnected with the aircraft wing exclusively via the strip element made of a resiliently flexible material, wherein a downstream edge of the strip element is extending along the whole upstream edge of the spoiler or at least along a major part of the upstream edge of the spoiler, and wherein a whole upstream edge of the strip element is connected to an upper surface of the aircraft wing.

The actuator powered mechanism is constructed and arranged such, that while moving the spoiler from the reference angle α_{ref} to the given target deflection angle α_{target}, the strip element is being bent with a constant strain along the strip element, wherein a cross-section of the strip element for all deflection angles α assumes the form of a ring segment with a radius R(α) at least within a given margin of failure, with α, α_{target}, α_{ref}ε[−α₁; α₂].

Preferably the actuator powered mechanism is integrated into the aircraft wing. The actuator powered mechanism may consist only of an actuator or comprise an actuator and a mechanism which is driven by the actuator.

In a preferred embodiment of the aircraft wing a passage from the upper surface of the aircraft wing via the upper surface of the strip element to the upper surface of the spoiler is a smooth and gapless surface.

In the proposed aircraft wing the strip element is exposed to a minimum bending strain resulting in a high fatigue endurance limit of the strip element.

In a preferred embodiment the minimum thickness of the strip element made of a given material/structure is defined by a given failure tolerance. For achieving a minimum bending strain the thickness of the strip element should be as small as possible. In a preferred embodiment the strip element is made of a metal, a metal alloy, a carbon fiber composite, a glass fiber composite or a mixture thereof.

Because of the proposed strip element and its respective bending an air flow over the spoiler is kept laminar to the maximum extent, thus reducing the overall aerodynamic drag of the aircraft wing especially when the spoiler is deployed. The strip element is replacing hinge connections used today for attaching spoilers to aircraft wings. These hinge connections typically lead to gaps between the upper surface of the aircraft wing and the spoiler surface producing turbulent airflows. The proposed strip element and its respective bending prevents or at least significantly reduces the production of turbulent air flow.

A preferred embodiment of the aircraft wing is characterized in that the target deflection angle α_{target} is being selected from the interval: αε[−30°; 60°] or [−20°; 60°] or [−15°; 60°] or [−10°; 50°]. The negative deflection angles α indicate a droop functionality of the spoiler wherein for example a landing flap connected with the aircraft wing is lowered and the spoiler is following the landing flap lowering within certain limits. In a preferred embodiment the spoiler is also able to follow a lift of such a landing flap producing variable cross-sections of the aircraft wing, a so-called “variable camber functionality”.

A preferred embodiment of the aircraft wing is characterized in that the given margin of failure indicating a deviation of the form of the actual cross-section of the strip element from the respective ring segment with a radius R(α) is less than 15% or 10% or 5% or 2% or 1%. The deviation is calculated based on methods known by a person having ordinary experience and the respective art. It is clear that the bending strain in the strip element is optimally reduced to a minimum when the deviation from the form of the actual cross-section of the strip element to the respective ring segment is a minimum (theoretically equalling zero).

A preferred embodiment of the aircraft wing is characterized in that the actuator powered mechanism comprises a guidance kinematic or a guidance rail, a guidance lever and an actuator, wherein the guidance kinematic is fixed to a contact C1 on an inner structure of the aircraft wing (e.g. the wing box), a first end of the guidance lever is rigidly connected to a contact C2 on a lower side of the spoiler, two connecting elements separated by a distance D are connected to a second end of the guidance lever, the connecting elements being movably coupled to the guidance kinematic, wherein the connecting elements are exclusively allowing a movement of the first end guidance lever along the guidance kinematic. The guidance kinematic has a longitudinal extension and a respective 3D-form.

In a preferred embodiment the guidance kinematic impresses a respective position and orientation onto the spoiler depending on the actual deflection angle α. The impressed position and orientation of the spoiler result in that the cross-section of the strip element optimally assumes the said form of a ring segment.

In a preferred embodiment the actuator powered mechanism is constructed such that it absorbs the majority of forces and moments from the spoiler and transfers these forces and moments to an inner structure of the aircraft wing.

A preferred embodiment is characterized in that the actuator of the actuator powered mechanism is fixed to an inner structure of the aircraft wing and connected to the guidance lever for moving the guidance lever along the guidance kinematic, with the movement being dependant on a given target deflection angle α_{target}, wherein any deflection angle αε[−α₁; α₂] corresponds to a distinct position of the guidance lever along the guidance bearing, and wherein the guidance kinematic has a 3D-form such that the spoiler for all deflection angles α is articulated by the guidance lever such that the cross-section of the flexible strip element for all deflection angles α assumes said form of a ring segment with a radius R(α) at least within a given margin of failure, with α, α_{target}; α_{ref}ε[−α₁; α₂].

In a preferred embodiment the connecting elements comprise rollers. The rollers enable a more or less frictionless movement of the guidance lever along the guidance kinematic.

The guidance kinematic may be selected from various variants, for example: horizontally and/or vertically moving, extending, or even introducing a reverse force by attaching a spring.

A preferred embodiment of the aircraft wing is characterized in that the actuator powered mechanism is constructed and arranged such that the majority of an air load on the spoiler is transferred via the actuator powered mechanism to the airfoil, wherein only a minimum of the air load is transferred to an actuator of the actuator powered mechanism or via the actuator to the inner structure of the aircraft wing respectively.

In a preferred embodiment the actuator powered mechanism nearly completely (90%-100%) absorbs the air loads (forces and moments), especially in a fully deployed status of the spoiler (α=αₘₐₓ=α₂), and transfers these loads to the inner structure of the aircraft wing, whereas the actuator of the actuator powered mechanism holds the spoiler nearly forceless. This leads to significant reductions of the requirements for the actuator and thus to significant cost and weight reductions.

A preferred embodiment of the aircraft wing is characterized in that the actuator powered mechanism is constructed such that 85% or 90% or 95% or 97% or 98% or 99% of the air load on the spoiler is transferred via the actuator powered mechanism to the aircraft wing and that less than 15%, or 10% or 5% or 3% or 2% or 1% are transferred to the actuator.

In a preferred embodiment the guidance lever is variable in its length L depending on deflection angle α: L=L(α) and/or on its geometry G(α).

In a preferred embodiment the actuator powered mechanism is constructed such that a virtual center position CP(α) of the ring segment with the radius R(α) varies with α in three-dimensional space allowing impressing the respective position and orientation onto the spoiler.

A preferred embodiment of the proposed aircraft wing is characterized in that the spoiler comprises at least the following segments: an upstream segment SEG₁ with a stiffness S₁, a downstream segment SEG₂ with a stiffness S₂, a connecting segment SEG₃ with a stiffness S₃, the connecting segment SEG₃ is connecting a downstream edge of SEG₁ with an upstream edge of SEG₂, the strip element connecting an upstream edge of SEG₁ to the upper surface of the aircraft wing, wherein at least the connecting segment SEG₃ possesses a mechanical pretension resulting in a convex shape of the upper surface of the spoiler, with S₃<S₁, S₂.

In this embodiment the spoiler may act as an adaptive shock control bump allowing an improvement of the performance of the aircraft wing and especially contributes to an improvement of the buffeting behaviour and a reduction of the characteristic impedance of the air aircraft wing. The shape of the shock control bump may be modified by the actuator powered mechanism when the spoiler is in the reference position.

In a preferred embodiment the actuator powered mechanism is constructed such that it allows even in case of a failure of the strip element a retraction and an extension of the spoiler. This is possible because the orientation and position of the spoiler is mechanically defined by the actuator powered mechanism. The actuator powered mechanism transfers nearly all forces and moments from the spoiler to the aircraft wing, whereas the strip element preferably does only transfer an irrelevant minimum of forces or moments from the spoiler to the aircraft wing. The main effect of the strip element is to keep a laminar flow in a boundary layer as long as possible leading to a reduction of aerodynamic drag of the aircraft wing. In case of failure of the strip element turbulent flow may occur but the spoiler itself would not be jeopardized in its functionality.

The proposed aircraft wing shows a gapless connection of the spoiler to the upper surface of the aircraft wing by the strip element leading to a reduction of aerodynamic drag. This aspect may be used on today's transonic and laminar aircraft wings. The proposed actuator powered mechanism absorbs nearly all forces and moments on the spoiler and transfers these forces and moments to an inner structure of the aircraft wing (e.g. the wing box), preferably without transferring these forces and moments via the actuator of the actuator powered mechanism to the aircraft wing. The forces and moments transferred by the strip element to the aircraft wing are insignificant and are mainly due to the impressed bending forces. The proposed aircraft wing is proving air flow across the wing both in extended and retracted positions of the spoiler.

A second aspect provides an aircraft or spaceship with an aircraft wing as described before.

### BRIEF DESCRIPTION OF THE DRAWINGS

FIG. 1 schematic cross-sectional view of the flexible strip element and geometric properties,

FIG. 2 schematic cross-sectional view of the aircraft wing with the spoiler in

deployed position, and

FIG. 3 schematic cross-sectional view of a proposed aircraft wing including a spoiler.

### DETAILED DESCRIPTION

The following description provides an approach for the estimation of occurring mechanical strain within the flexible strip element for deployed spoiler positions, i.e. α≠α_{ref}. Furthermore, the traces of the moving end point and a guidance point are determined based on a deflection angle α of the spoiler.

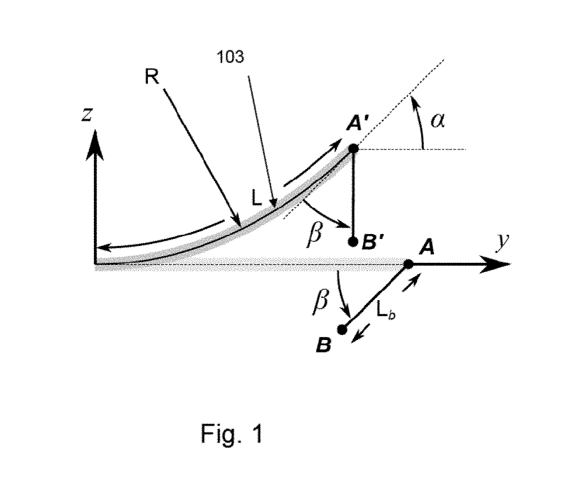

The principle geometry of the flexible strip element is shown in FIG. 1. The main flow direction is orientated along the y-axis. The elevation above the aircraft wing surface is orientated along the z-axis. At y=0 the upstream edge of the strip element is connected to the upper surface of the aircraft wing. The strip element is assumed to bend in a circular shape of radius R. The length L of the strip element stays constant, implying zero extensional strain. The strip element is deformed such that at its end point A the strip element is inclined by an angle α which is the deflection angle α of the spoiler.

Consequently, the criterion of maximum strain reduces to a pure geometric problem with no mechanical properties being involved. The bending moment is assumed constant along the strip element. However, large displacements must obviously be taken into account.

Trace of a Guidance Point A

A point P on the deformed strip element is bound to the circular shape, its location follows

y²+(R−z)²=R² (1)

or making use of the involved quantities being always positive,

y=\sqrt{z²−2Rz} or z=R−\sqrt{R²−y²} (2)

The length L of the strip element is constant, and may be expressed with the angle α from the circle's circumference,

L=αR. (3)

The angle α may be expressed using the tangens of a triangle from the circle centre to the point P to the point projected onto the z-axis,

$$tan α = \frac{y}{R - z} \qquad ( 4 )$$

or alternatively from the slope of the circular curve, using the right of (2),

$$tan α = \frac{dz}{dy} = \frac{y}{\sqrt{{R}^{2} - {y}^{2}}} \qquad ( 5 )$$

Solving the latter for y² yields

$${y}^{2} = \frac{{R}^{2} {tan}^{2} α}{1 + {tan}^{2} α} = {R}^{2} {sin}^{2} α \qquad ( 6 )$$

which after substituting (3) for R reveals a trace of point A in terms of α as

yₐ=(L/α)sin α,zₐ=(αL/2)(1−α²/12) (7)

This solution unfortunately bears an impractical singularity for the undeformed strip element at zero α. For that matter, a series expansion about α approaching zero and up to the second order terms yields

y=L(1−α²/6),z_{b}=zₐ−L_{b} sin(α+β) (8)

providing the expected position of the undeformed strip element. Hence, (7) is the sought trace of the end point A with respect to an externally applied rotation α.

Trace of a Guidance Point B

Suppose a point B with a constant distance L_{B} from point A at an initial inclination angle β, following the rotation of point A. Then its trace is subject to

y_{b}=yₐ−L_{b} cos(α+β),z_{b}=zₐ−L_{b} sin(α+β) (9)

This formulation permits two of the parameters of length L_{b}, angle β, and coordinates y_{b}, z_{b} to be pre-defined. Accordingly, the remaining two parameters would be the result of the movement of the flexible strip element. This allows various variants of a guidance kinematic, for instance horizontally or vertically moving, extending, or possibly even introducing a reverse force by attaching a spring.

Bending Surface Strains

The (linear) strains of a particle with the distance z to the mid-plane of a shell is determined by

ε=ε₀±zκ₀ (10)

where ε₀ is the extensional strain and κ₀ the curvature at a mid-plane. The curvature of a circle is revealed by

κ₀=1/R (11)

Due to the assumption of inextensible deformation, ε₀=0, the strains at the surface of the shell of thickness t read

$${ɛ}_{min / max} = \frac{t}{2 R} = \frac{α t}{2 L} \qquad ( 12 )$$

from which one may infer the minimum length given maximum strain allowable and a desired angle of inclination as

$$L \geq \frac{α t}{2 {ɛ}_{allowed}} \qquad ( 13 )$$

and in which ε_{allowed} reflects the minimum absolute value of tensional and compressive strain allowable.

Radius of Curvature of Guidance Curve

The center of the guidance curve CP(α) in dependence of the deflection angle α may be inferred with

$${y}_{b}^{′} = \frac{\partial {y}_{b}}{\partial α} , {y}_{b}^{″} = \frac{{\partial }^{2} {y}_{b}}{\partial {α}^{2}} , {z}_{b}^{′} = \frac{\partial {z}_{b}}{\partial α} , {z}_{b}^{″} = \frac{{\partial }^{2} {z}_{b}}{\partial {α}^{2}} \qquad ( 14 )$$

from

$${R}_{b} = \frac{{( {( \frac{{dy}_{b}}{d α} )}^{2} + {( \frac{{dz}_{b}}{d α} )}^{2} )}^{3 / 2}}{\vert \frac{{dy}_{b}}{d α} \frac{{d}^{2} {z}_{b}}{d {α}^{2}} - \frac{{dz}_{b}}{d α} \frac{{d}^{2} {y}_{b}}{d {α}^{2}} \vert} = \frac{{( {y}_{b}^{′2} + {z}_{b}^{′2} )}^{3 / 2}}{\vert {y}_{b}^{′} {z}_{b}^{″} - {z}_{b}^{′} {y}_{b}^{″} \vert} {R}_{b} = {R}_{b} ( α ) \qquad ( 15 )$$

The location of the curvature center CP(α) is then found with

$$\begin{matrix}{y}_{c} = {y}_{b} - {R}_{b} cos arctan ( \frac{{y}_{b}^{′}}{{z}_{b}^{′}} ) , ( {y}_{c} = {y}_{c} ( α ) ) & ( 16 ) \\ {z}_{c} = {z}_{b} - {R}_{b} sin arctan ( \frac{{y}_{b}^{′}}{{z}_{b}^{′}} ) , ( {z}_{c} = {z}_{c} ( α ) ) & ( 17 )\end{matrix}$$

Kinematic Loads

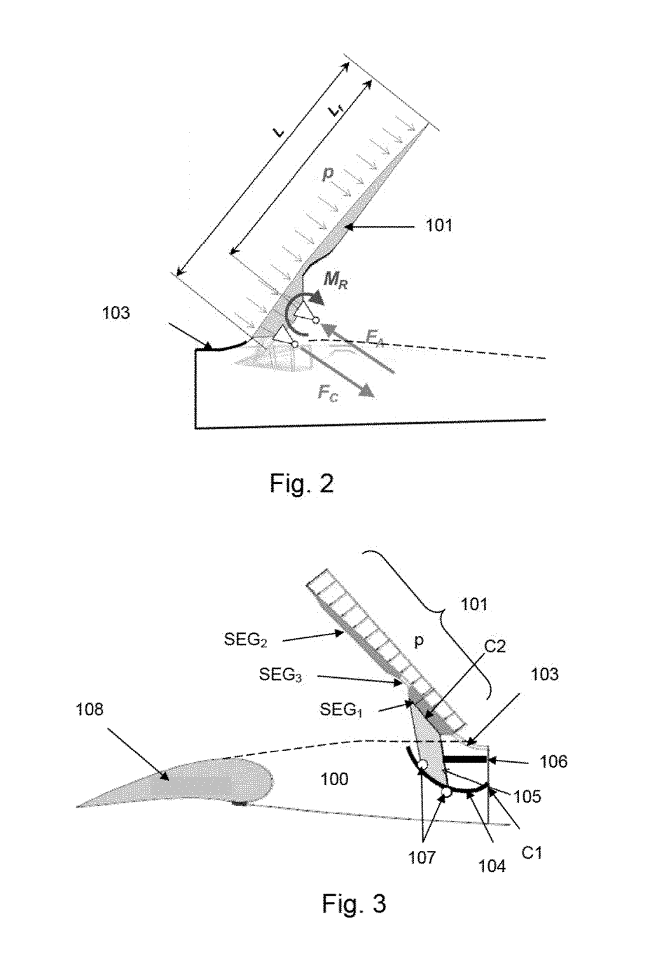

The spoiler (see FIG. 2) is subject to a constant pressure p acting in normal direction to the spoiler surface of total length L. The actuator kinematic is located at distance L_{f} from the downstream edge of the spoiler. The total force per lateral unit length the actuator kinematic is required to provide is

F_{A}=F_{C}+pL

in which F_{C} is the load required by the counter kinematic to eliminate the resulting bending moment:

$${M}_{R} = \frac{p}{2} {( L - {L}_{f} )}^{2} - \frac{p}{2} {L}_{f}^{2} + {F}_{c} {L}_{c} = pL ( \frac{L}{2} - {L}_{f} ) + {F}_{c} {L}_{c}$$

Supposing the counter kinematic is located at the inside spoiler edge, L_{C}=L−L_{f}, then a zero bending moment, M_{R}=0, is achieved when

$${F}_{A} = \frac{pL}{2} ( \frac{{L}_{f}}{L - {L}_{f}} - 1 ) .$$

F_{C} obviously becomes zero, if the actuator kinematic is located in the center of the spoiler cord, L_{f}=L/2. With F_{C} the actuator force is obtained as

$${F}_{A} = \frac{pL}{2} ( \frac{{L}_{f}}{L - {L}_{f}} + 1 )$$

which simply is the pressure resultant increased by the counter force.

FIG. 3 illustrates a schematic cross-sectional view of a proposed aircraft wing 100 with a spoiler 101 and a trailing edge flap 108. The spoiler 101 is being movable from a reference position with a deflection angle α_{ref} to a given target deflection angle α_{target} by an actuator powered mechanism.

The spoiler 101 is interconnected with the aircraft wing exclusively via a strip element 103 and via the actuator powered mechanism, wherein an upstream edge of the spoiler 101 is being interconnected with the aircraft wing 100 exclusively via the strip element 103 made of a resiliently flexible material, wherein a downstream edge of the strip element 103 is extending along the whole upstream edge of the spoiler 101 and wherein a whole upstream edge of the strip element 103 is connected to an upper surface of the aircraft wing. The passage from the upper surface of the aircraft wing 100 via the upper surface of the strip element 103 to the upper surface of the spoiler 101 is a smooth and gapless surface.

The actuator powered mechanism is constructed and arranged such that while moving the spoiler 101 from the reference angle α_{ref} to the given target deflection angle α_{target}, the strip element 103 is being bent with a constant strain along the strip element 103, wherein a cross-section of the strip element 103 for all deflection angles α assumes the form of a ring segment with a radius R(α) at least within a given margin of failure, with α, α_{target}, α_{ref}ε[−α₁; α₂].

In the illustrated example the actuator powered mechanism comprises a guidance kinematic 104, a guidance lever 105 and an actuator 106, wherein the guidance kinematic 104 is fixed to a contact C1 on an inner structure of the aircraft wing (wing box), a first end of the guidance lever 105 is rigidly connected to a contact C2 on a lower side of the spoiler 101. Two connecting elements 107 separated by a distance D are connected to a second end of the guidance lever 105. The connecting elements 107 being movably coupled to the guidance kinematic 104, wherein the connecting elements 107 are exclusively allowing a movement of the first end guidance lever 105 along the guidance kinematic 104.

The actuator 106 is fixed to an inner structure (wing box) of the aircraft wing 100 and further is connected to the guidance lever 105 for moving the guidance lever 105 along the guidance kinematic 104. The movement of the guidance lever 105 being dependant on a given target deflection angle α_{target}, wherein any deflection angle αε[−α₁; α₂] corresponds to a distinct position of the guidance lever 105 along the guidance kinematic 104, and wherein the guidance kinematic 104 has a 3D-form such that the spoiler 101 for all deflection angles α is articulated by the guidance lever 105 such that the cross-section of the flexible strip element 103 for all deflection angles α assumes the form of a ring segment with a radius R(α) at least within a given margin of failure, with α, α_{target}, α_{ref}ε[−α₁; α₂].

The spoiler 101 comprises the following segments: an upstream segment SEG₁ with a stiffness S₁, a downstream segment SEG₂ with a stiffness S₂, and a connecting segment SEG₃ with a stiffness S₃. The connecting segment SEG₃ is connecting a downstream edge of SEG₁ with an upstream edge of SEG₂ and the strip element 103 is connecting an upstream edge of SEG₁ to the upper surface of the aircraft wing 100. The connecting segment SEG₃ possesses a mechanical pretension, which results in a given convex shape of the upper surface of the spoiler 101, with S₃<S₁, S₂.

The terms “upstream” and “downstream” are referring to a main flow direction across the aircraft wing when airborne. The term “cross-section” for example refers to a cross-section along the main flow direction across the wing or along the longitudinal axis of the aircraft.

The term “stiffness” refers to a structural (mechanical) stiffness of the respective segment or strip element 103. In a preferred embodiment the segments SEG₁, SEG₂ are made of a metal, a metal alloy, a carbon fiber composite, a glass fiber composite or a mixture thereof. In a preferred embodiment the interconnecting segment SEG₃ and/or the strip element 103 are made of a metal, a metal alloy, a carbon fiber composite, a glass fiber composite or a mixture thereof. In a preferred embodiment the stiffness of segments SEG₁ and/or SEG₂ are selected such that said segments are dimensionally stable at least under operational air loads on the upper surface element. In a preferred embodiment the stiffness of segment SEG₃ is selected such that, firstly based on the mechanical pretension a convex shape of the upper surface element is conserved if no forces, especially no forces induced by the actuator 105 are acting on the spoiler, and secondly that the interconnecting segment SEG₃ is resiliently flexible enough for allowing a variation of the shape of the upper surface of the spoiler induced by the actuator 106. In a preferred embodiment the stiffness S₁ equals the stiffness S₂: S₁=S₂.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

100 aircraft wing
101 spoiler
102 actuator powered mechanism
103 flexible strip element
104 guidance kinematic
105 guidance lever
106 actuator of the actuator powered mechanism
107 connecting elements
108 trailing edge flap

1. An aircraft wing with a spoiler, the spoiler being movable from a reference position with a deflection angle α_{ref} to a given target deflection angle α_{target} by an actuator powered mechanism wherein
the spoiler is interconnected with the aircraft wing exclusively via a strip element and via the actuator powered mechanism, wherein
an upstream edge of the spoiler is interconnected with the aircraft wing exclusively via the strip element made of a resiliently flexible material, wherein a downstream edge of the strip element extends along the whole upstream edge of the spoiler or at least along a major part of the upstream edge of the spoiler and wherein a whole upstream edge of the strip element is connected to an upper surface of the aircraft wing, and
the actuator powered mechanism is constructed and arranged such that while moving the spoiler from the reference angle α_{ref} to the given target deflection angle α_{target}, the strip element is bent with a constant strain along the strip element, wherein a cross-section of the strip element for all deflection angles α assumes the form of a ring segment with a radius R(α) at least within a given margin of failure, with α, α_{target}, α_{ref}ε[−α₁; α₂].

2. The aircraft wing of claim 1, wherein a passage from the upper surface of the aircraft wing via the upper surface of the strip element to the upper surface of the spoiler is a smooth surface.

3. The aircraft wing of claim 1, wherein the spoiler is a high lift spoiler.

4. The aircraft wing of claim 1, wherein the target deflection angle α_{target} is selected from the interval: αε[−30°; 60°].

5. The aircraft wing of claim 1, wherein the given margin of failure indicating a deviation of the form of the actual cross-section of the strip element from the respective ring segment with a radius R(α) is less than 15%.

6. The aircraft wing of claim 1,
wherein the actuator powered mechanism comprises a guidance kinematic, a guidance lever and an actuator, wherein:
the guidance kinematic is fixed to a contact C1 on an inner structure of the airfoil,
a first end of the guidance lever is rigidly connected to a contact C2 on a lower side of the spoiler,
two connecting elements separated by a distance D are connected to a second end of the guidance lever,
the connecting elements are movably coupled to the guidance kinematic, wherein the connecting elements exclusively allow a movement of the first end guidance lever along the guidance kinematic,
the actuator is fixed to an inner structure of the aircraft wing and further is connected to the guidance lever for moving the guidance lever along the guidance kinematic, the movement being dependant on a given target deflection angle α_{target}, and
wherein any deflection angle αε[−α₁; α₂] corresponds to a distinct position of the guidance lever along the guidance kinematic, and wherein the guidance kinematic has a 3D-form such that the spoiler for all deflection angles α is articulated by the guidance lever such that the cross-section of the flexible strip element for all deflection angles α assumes the form of said ring segment with a radius R(α) at least within a given margin of failure, with α, α_{target}, α_{ref}ε[−α₁; α₂].

7. The aircraft wing of claim 6, wherein the connecting elements comprise rollers.

8. The aircraft wing of claim 1, wherein the actuator powered mechanism is constructed and arranged such that the majority of an air load on the spoiler is transferred via the actuator powered mechanism to the airfoil, wherein a minimum of the air load is transferred to an actuator of the actuator powered mechanism.

9. The aircraft wing of claim 8, wherein the actuator powered mechanism is constructed such that 85% of the air load on the spoiler is transferred via the actuator powered mechanism to the aircraft wing and that less than 15%, are transferred to the actuator.

10. The aircraft wing of claim 6, wherein the guidance lever is variable in its length L depending on deflection angle α: L=L(α).

11. The aircraft wing of claim 1, wherein the actuator powered mechanism is integrated in the aircraft wing.

12. The aircraft wing of claim 1, wherein a virtual center position CP(α) of the ring segment with the radius R(α) varies with α.

13. The aircraft wing of claim 1, wherein the spoiler comprises at least the following segments:
an upstream segment SEG₁ with a stiffness S₁,
a downstream segment SEG₂ with a stiffness S₂,
a connecting segment SEG₃ with a stiffness S₃, the connecting segment SEG₃ is connecting a downstream edge of SEG₁ with an upstream edge of SEG₂,
the strip element connecting an upstream edge of SEG₁ to the upper surface of the aircraft wing,
wherein at least the connecting segment SEG₃ possesses a mechanical pretension, which would, if no forces are acting on the spoiler, result in a given convex shape of the upper surface of the spoiler, with S₃<S₁, S₂.

14. The aircraft wing (100) of claim 1, wherein a virtual center position CP(α) of the ring segment with the radius R(α) varies with α.

15. An aircraft or spaceship with an aircraft wing, wherein the aircraft wing comprises a spoiler, the spoiler being movable from a reference position with a deflection angle α_{ref} to a given target deflection angle α_{target} by an actuator powered mechanism wherein
the spoiler is interconnected with the aircraft wing exclusively via a strip element and via the actuator powered mechanism, wherein
an upstream edge of the spoiler is interconnected with the aircraft wing exclusively via the strip element made of a resiliently flexible material, wherein a downstream edge of the strip element extends along the whole upstream edge of the spoiler or at least along a major part of the upstream edge of the spoiler and wherein a whole upstream edge of the strip element is connected to an upper surface of the aircraft wing, and the actuator powered mechanism is constructed and arranged such that while moving the spoiler from the reference angle α_{ref} to the given target deflection angle α_{target}, the strip element is bent with a constant strain along the strip element, wherein a cross-section of the strip element for all deflection angles α assumes the form of a ring segment with a radius R(α) at least within a given margin of failure, with α, α_{target}, α_{ref}ε[−α₁; α₂].
